(19) United States
(12) Patent Application Publication
(10) Pub. No.: US 2026/0363332 A1
(43) Pub. Date: Nov. 19, 2026

(54) AEROSOL GENERATING DEVICE

(71) Applicant: Shenzhen Merit Technology Co., Ltd, Shenzhen (CN)

(72) Inventor: Peng CHENG, Shenzhen (CN)

(73) Assignee: Shenzhen Merit Technology Co., Ltd, Shenzhen (CN)

(21) Appl. No.: 19/721,089

(22) Filed: Jun. 26, 2026

Related U.S. Application Data
(63) Continuation of application No. PCT/CN2024/120658, filed on Sep. 24, 2024.

(30) Foreign Application Priority Data
Dec. 27, 2023 (CN) 202323605357.6

(51) Int. Cl. A24F 40/53; A24F 40/46; A24F 40/51; H05B 1/02

(52) U.S. Cl. CPC A24F 40/53; A24F 40/46; A24F 40/51; H05B 1/0252

(57) ABSTRACT

An aerosol generating device includes a body, a cover body, and a detection assembly. The detection assembly including a movable component. When the cover body is in a first state, the cover body is connected to the body. A first detecting member of the detection assembly detects a state of the movable component relative to a through hole. When the cover body is in a second state, a second detecting member of the movable component exceeds a detection range of the first detecting member.

### RELATED APPLICATION(S)

The present disclosure is a continuation application of International application No. PCT/CN2024/120658, filed on Sep. 24, 2024, which claims priority to Chinese Patent Application No. 202323605357.6, filed on Dec. 27, 2023. The entire disclosure of the prior applications is hereby incorporated by reference.

### TECHNICAL FIELD

This application relates to the field of atomization technologies, including to an aerosol generating device.

### BACKGROUND

An aerosol generating device is a small-sized device that can heat an aerosol generating substrate in a heat-not-burn (HNB) manner and generate an aerosol. A housing of the aerosol generating device is provided with a cavity and a through hole, and the aerosol generating substrate can extend into the cavity through the through hole. In the related art, the aerosol generating device is provided with a shielding member capable of shielding or opening the through hole. After the aerosol generating substrate is removed from the cavity, the shielding member can shield the through hole to prevent foreign objects from entering the cavity. After the aerosol generating substrate is removed from the cavity, residue may remain in the cavity. Therefore, a user needs to clean the interior of the cavity to prevent the residue from affecting mounting of the aerosol generating substrate. However, the arrangement of the shielding member affects a cleaning operation by the user. For example, the user needs to apply force to the shielding member to open the through hole, resulting in a greater operational burden on the user and lower cleaning efficiency.

### SUMMARY

The aerosol generating device of this application includes a body, a cover body, and a detection assembly. The body is provided with a heating cavity, and the heating cavity is configured to accommodate an aerosol generating substrate. The cover body is provided with a through hole that is in communication with the heating cavity, and the cover body is switchable between a first state and a second state relative to the body. The detection assembly includes a movable component and a detecting member. The movable component is arranged on the cover body and is movable relative to the cover body to be in a state of shielding the through hole or a state of opening the through hole. The movable component includes a detected member. When the cover body is in the first state, the cover body is connected to the body, and the detecting member detects a state of the movable component relative to the through hole. When the cover body is in the second state, the detected member exceeds a detection range of the detecting member.

### BRIEF DESCRIPTION OF THE DRAWINGS

The above and/or additional aspects and advantages of this application will become apparent and readily understandable from the following descriptions of the implementations in conjunction with the following accompanying drawings.

FIG. 1 is a schematic three-dimensional structural view of an aerosol generating device according to an aspect of this application;

FIG. 2 is a schematic cross-sectional view of an aerosol generating device and an aerosol generating substrate according to an aspect of this disclosure;

FIG. 3 is a schematic cross-sectional view of the aerosol generating device shown in FIG. 1;

FIG. 4 is a schematic three-dimensional structural view of a movable component of a detection assembly in the aerosol generating device shown in FIG. 1;

FIG. 5 is a schematic structural view of an implementation in which a cover body is in a second state in the aerosol generating device shown in FIG. 1;

FIG. 6 is a schematic structural view of another implementation in which the cover body is in a second state in the aerosol generating device shown in FIG. 1; and

FIG. 7 is a schematic structural view of still another implementation in which the cover body is in the second state in the aerosol generating device shown in FIG. 1.

Descriptions of reference numerals of main elements:
aerosol generating device 100; aerosol generating substrate 200; first direction X; second direction Y;
body 10, heating cavity 11, opening 13, housing 15, holder 17;
cover body 20, through hole 21;
detection assembly 30, movable component 31, rotating shaft 311, shielding member 313, detected member 315, elastic member 317, detecting member 33;
connection assembly 40, first connector 41, second connector 43; power supply unit 50;
heating component 60.

### DETAILED DESCRIPTION

To make the foregoing objects, features and advantages of this disclosure more apparent and understandable, specific implementations of this disclosure are described in detail below with reference to the accompanying drawings. In the following descriptions, many specific details are described to help fully understand this disclosure. However, this disclosure can be implemented in many other manners different from those described herein. A person skilled in the art may make similar improvements without violating connotation of this disclosure. Therefore, this disclosure is not limited to the specific embodiments disclosed below.

In this disclosure, it should be understood that orientations or position relationships indicated by terms such as “central”, “length”, “upper”, “lower”, “front”, “back”, “vertical”, “horizontal”, “top”, “bottom”, “inner”, and “outer”, are orientations or position relationships shown based on the accompanying drawings, and these terms are merely intended to facilitate the description of this disclosure and simplify the description, instead of indicating or implying that the mentioned device or elements must have a particular orientation or be constructed and operated in a particular orientation. Therefore, these terms should not be construed as a limitation to this disclosure.

In addition, the terms “first” and “second” are used merely for the purpose of description, and should not be construed as indicating or implying relative importance or implicitly indicating the number of indicated technical features. Therefore, features defined by “first” and “second” can explicitly or implicitly include at least one of the features. In the descriptions of this disclosure, “a plurality of” means at least two, for example, two or three, unless otherwise clearly and specifically defined.

In this disclosure, unless otherwise clearly stipulated and limited, the terms “mount”, “interconnect”, and “connect” should be understood in a generalized manner, for example, may be understood as a fixed connection, a detachable connection, or integration; or may be understood as a mechanical connection or an electrical connection; or may be understood as a direct connection, an indirect connection via a medium, an internal communication of two elements, or an interaction relationship between two elements. A person of ordinary skill in the art may understand specific meanings of the foregoing terms in this disclosure according to specific situations.

In this disclosure, unless otherwise explicitly specified and defined, a first feature being “on” or “under” a second feature may mean that the first feature and the second feature are in direct contact, or the first feature and the second feature are in indirect contact through an intermediary. In addition, the first feature being “above”, “over”, or “on” the second feature may mean that the first feature is directly above or obliquely above the second feature, or may merely indicate that the horizontal position of the first feature is higher than the horizontal position of the second feature. The first feature being “below”, “under”, or “beneath” the second feature may be that the first feature is directly below or obliquely below the second feature, or may merely indicate that the horizontal position of the first feature is lower than the horizontal position of the second feature.

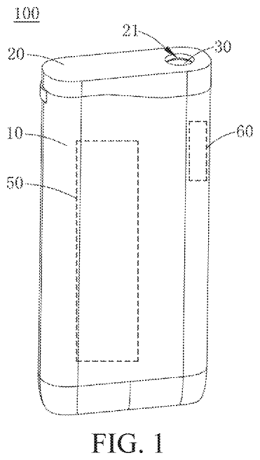

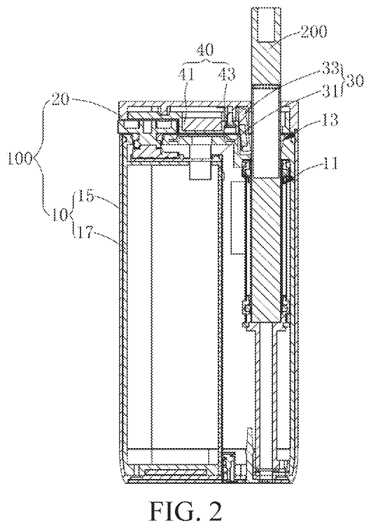

Referring to FIG. 1 and FIG. 2, an aerosol generating device 100 of the implementations of this disclosure includes a body 10, a cover body 20, and a detection assembly 30. The body 10 is provided with a heating cavity 11, and the heating cavity 11 is configured to accommodate an aerosol generating substrate 200. The cover body 20 is provided with a through hole 21 that is in communication with the heating cavity 11, and the cover body 20 is switchable between a first state and a second state relative to the body 10. The detection assembly 30 includes a movable component 31 and a detecting member 33. The movable component 31 is arranged on the cover body 20 and is movable relative to the cover body 20 to be in a state of shielding the through hole 21 or a state of opening the through hole 21. The movable component 31 includes a detected member 315. When the cover body 20 is in the first state, the cover body 20 is connected to the body 10, and the detecting member 33 detects a state of the movable component 31 relative to the through hole 21. When the cover body 20 is in the second state, the detected member 315 exceeds a detection range of the detecting member 33. It should be noted that, in an aspect, the detecting member 33 can detect the movable component 31 to determine whether the aerosol generating substrate 200 is accommodated in the heating cavity 11.

In an aspect, the body 10 includes a housing 15, and the aerosol generating device 100 may further include a power supply unit 50 and a heating component 60. The power supply unit 50 is electrically connected to both the detecting member 33 and the heating component 60, and is configured to supply power to the detecting member 33 and the heating component 60. The heating component 60 is electrically connected to the detecting member 33. When the detecting member 33 determines that the aerosol generating substrate 200 is accommodated in the heating cavity 11, the heating component 60 heats the aerosol generating substrate 200. It should be noted that, in an aspect, the heating component 60 is a structure capable of generating thermal energy or transferring thermal energy to other parts. In an aspect, the heating component 60 is capable of directly converting energy in another form, such as electric energy, chemical energy, or solar energy, into thermal energy, and conducting, through heat conduction, the thermal energy to other parts to be heated. In some other implementations, the heating component 60 is capable of emitting energy in another form, such as an electromagnetic wave, a laser beam, infrared light, or thermal radiation that can directly act on a surface of a portion to be heated, to increase a temperature of a region that receives the electromagnetic wave, the laser beam, the infrared light, or the thermal radiation.

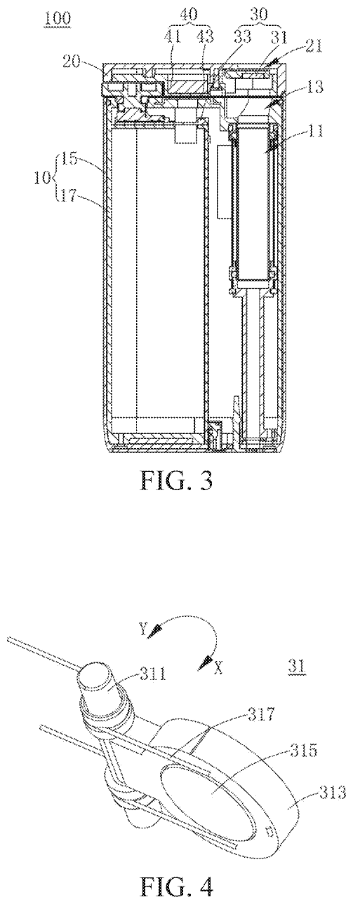

Referring to FIG. 3, in an aspect, the power supply unit 50 and the heating component 60 are both arranged in the housing 15. In this way, the housing 15 is capable of protecting the power supply unit 50 and the heating component 60. When the detecting member 33 detects the movable component 31 (the detected member 315) to determine that the aerosol generating substrate 200 is accommodated in the heating cavity 11 (as shown in FIG. 2), the detecting member 33 can output a heating signal. In this case, the power supply unit 50 can supply power to the heating component 60 to enable the heating component 60 to heat and atomize the aerosol generating substrate 200 according to the heating signal. When the detecting member 33 detects the movable component 31 (the detected member 315) to determine that the aerosol generating substrate 200 is not accommodated in the heating cavity 11 (as shown in FIG. 3), the detecting member 33 can output an off signal or stop outputting a heating signal. In this case, the power supply unit 50 does not supply power to the heating component 60, and the heating component 60 stops heating the aerosol generating substrate 200.

In an aspect, the entire movable component 31 may be the detected member 315. In this way, accuracy and sensitivity of detecting the detected member 315 by the detecting member 33 can be improved, thereby ensuring working stability and reliability of the aerosol generating device 100. For example, when the detected member 315 is a magnetic element, the entire movable component 31 being the magnetic element can provide a stronger magnetic field, thereby improving detection accuracy and sensitivity of the detecting member 33. In some other embodiments, a part of the movable component 31 is the detected member 315. In this way, an arrangement position of the detected member 315 can be adaptively adjusted based on a mounting position of the detecting member 33, thereby improving working stability and reliability of the detection assembly 30.

It may be understood that the detecting member 33 can output other determining signals. For example, when the detecting member 33 detects the movable component 31 to determine that the aerosol generating substrate 200 is accommodated in the heating cavity 11, the detecting member 33 outputs a signal for triggering the aerosol generating device 100 to switch from a sleep state to a standby state, instead of a heating signal,.

In the implementations of this disclosure, description is provided merely by using an example in which the detecting member 33 outputs a heating signal when the detecting member 33 detects the movable component 31 to determine that the aerosol generating substrate 200 is accommodated in the heating cavity 11.

In an aspect, the body 10 is provided with an opening 13 that is in communication with the heating cavity 11, and the aerosol generating substrate 200 extends through the opening 13 and is accommodated in the heating cavity 11. When the cover body 20 is in the first state, the opening 13 corresponds to the through hole 21, and the movable component 31 is capable of blocking communication between the through hole 21 and the opening 13. When the cover body 20 is in the second state, the cover body 20 opens the opening 13.

Further, in an aspect, the body 10 may further include a holder 17 mounted in the housing 15. The holder 17 is provided with the heating cavity 11 and the opening 13 that is in communication with the heating cavity 11. In addition, the cover body 20 is provided with the through hole 21 that is in communication with the heating cavity 11. In other words, the heating cavity 11 can communicate with the outside through the through hole 21. Therefore, the aerosol generating substrate 200 can pass through the through hole 21 and the opening 13 successively and extend into the heating cavity 11.

When the aerosol generating substrate 200 extends into the heating cavity 11 through the through hole 21 and the opening 13, the aerosol generating substrate 200 can push the movable component 31 to move (including moving and rotation) relative to the cover body 20 to cause the movable component 31 to be in the state of opening the through hole 21. In this way, the aerosol generating substrate 200 is enabled to pass through the through hole 21 and the opening 13 successively and extend into the heating cavity 11. In this case, the detecting member 33 can detect the detected member 315 to determine that the aerosol generating substrate 200 is accommodated in the heating cavity 11, thereby causing the heating component 60 to heat the aerosol generating substrate 200 to generate an aerosol for inhalation by a user. When the user stops using the aerosol generating device 100, the aerosol generating substrate 200 can be removed, so that the user can store the aerosol generating device 100. In this case, the movable component 31 can move relative to the cover body 20 to be in the state of shielding the through hole 21, and the detecting member 33 can detect the detected member 315 to determine that the aerosol generating substrate 200 is not accommodated in the heating cavity 11, thereby causing the heating component 60 to stop heating the aerosol generating substrate 200. This can prevent damage to the heating component 60 caused by continuous heating. In addition, the arrangement of the movable component 31 can further prevent external impurities such as water or dust from entering the body 10 through the through hole 21 and causing damage to components in the body 10, and prevent the external impurities such as water or dust from entering the heating cavity 11 through the through hole 21 and causing the aerosol generating substrate 200 not to be mounted, thereby ensuring normal working of the aerosol generating device 100.

The aerosol generating substrate 200 is an element capable of generating an aerosol. The aerosol generating substrate 200 may be made into fine particles by means of heating or ultrasonic vibration, and mixed with air to form an aerosol. The aerosol generating substrate 200 may be in a solid form or a liquid form. The aerosol generating substrate 200 may be in the shape of a sheet, a column, or the like. In this disclosure, the aerosol generating substrate 200 is cylindrical. The aerosol may be visible or invisible and may include vapor (for example, fine particulate substances in a gaseous state that are typically liquid or solid at room temperature) as well as liquid droplets of gas and condensed vapor. The term “aerosol” in this specification covers an aerosol generated when the aerosol generating substrate 200 in the HNB aerosol generating device 100 is heated.

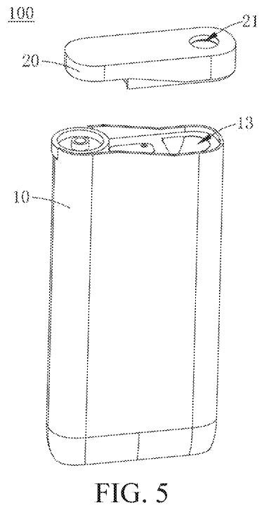

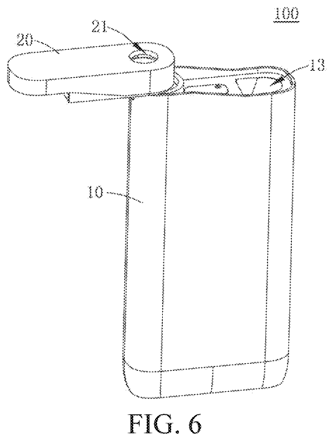

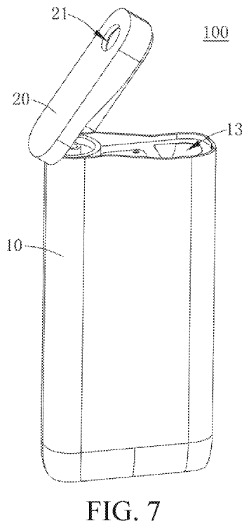

In an aspect, the first state (as shown in FIG. 2 or FIG. 3) may be a state of the cover body 20 when the cover body 20 is connected to the body 10, the through hole 21 corresponds to the opening 13, and the movable component 31 can block communication between the through hole 21 and the opening 13. The second state (as shown in FIG. 5, FIG. 6, or FIG. 7) may be a state of the cover body 20 when the cover body 20 is at least partially disconnected from the body 10 and the cover body 20 opens the opening 13. It may be understood that, in an aspect, switching of the cover body 20 between the first state and the second state requires manual intervention, that is, the cover body 20 is manually switched between the first state and the second state. Alternatively, the cover body 20 is switched between the first state and the second state manually with a tool.

In an aspect, when the cover body 20 is in the first state, if the movable component 31 moves relative to the cover body 20 to be in the state of opening the through hole 21, the movable component 31 can enter the detection range of the detecting member 33. If the movable component 31 moves relative to the cover body 20 to be in the state of shielding the through hole 21, the detected member 315 exceeds the detection range of the detecting member 33. In this way, when the cover body 20 is in the first state, the detecting member 33 can detect the movable component 31 to determine whether the aerosol generating substrate 200 is accommodated in the heating cavity 11. When the cover body 20 is in the second state, regardless of whether the movable component 31 is in the state of shielding the through hole 21 or the state of opening the through hole 21, the detected member 315 exceeds the detection range of the detecting member 33. Therefore, when the cover body 20 is in the second state, the detecting member 33 cannot detect the movable component 31 to determine whether the aerosol generating substrate 200 is accommodated in the heating cavity 11. It may be understood that, in an aspect, when the cover body 20 is in the second state, the cover body 20 opens the opening 13, so that a user can perform a cleaning operation on the heating cavity 11.

In the aerosol generating device 100 of this disclosure, the cover body 20 is switchable between the first state and the second state, and when the cover body 20 is in the second state, the detected member 315 exceeds the detection range of the detecting member 33. In this way, the movable component 31 does not affect a cleaning operation by a user, making it easier for the user to clean the heating cavity 11, thereby reducing an operational burden on the user and improving cleaning efficiency.

In addition, after the aerosol generating substrate 200 is removed from the heating cavity 11, residue may remain in the heating cavity 11. Therefore, the user needs to clean the interior of the heating cavity 11 to prevent the residue from affecting mounting and heating of the aerosol generating substrate 200. Generally, the user can insert a tool (such as a cotton swab) into the heating cavity 11 to clean the heating cavity 11. However, during the insertion of the tool into the heating cavity 11, the movable component 31 is rotatable relative to the cover body 20 to be in the state of opening the through hole 21. In this case, the movable component 31 is located within the detection range of the detecting member 33. Consequently, the heating component 60 starts to heat, which is not expected by the user, affecting normal cleaning by the user.

However, in the examples of this disclosure, when the cover body 20 is in the second state, the cover body 20 opens the opening 13, and the detected member 315 exceeds the detection range of the detecting member 33. Therefore, during cleaning of the heating cavity 11 by the user, the detecting member 33 does not cooperate with the movable component 31 to output a heating signal, that is, the heating component 60 does not start incorrectly, thereby ensuring normal cleaning of the heating cavity 11 by the user.

The aerosol generating device 100 is further described below with reference to the accompanying drawings.

Referring to FIG. 2 to FIG. 4, in an aspect, the movable component 31 is rotatable relative to the cover body 20 to switch between the state of shielding the through hole 21 and the state of opening the through hole 21. In some other implementations, the movable component 31 is movable relative to the cover body 20 to switch between the state of shielding the through hole 21 and the state of opening the through hole 21. It should be noted that, in the implementations of this disclosure, description is provided merely by using an example in which the movable component 31 is rotatable relative to the cover body 20 to switch between the state of shielding the through hole 21 and the state of opening the through hole 21.

Referring to FIG. 2 to FIG. 4, in an aspect, the movable component 31 includes a rotating shaft 311, a shielding member 313, the detected member 315, and an elastic member 317. The rotating shaft 311 is rotatably mounted on the cover body 20. The shielding member 313 is connected to the rotating shaft 311 and rotatable together with the rotating shaft 311. The detected member 315 is arranged on the shielding member 313 and rotatable together with the shielding member 313. The detected member 315 is configured to cooperate with the detecting member 33. The elastic member 317 is connected to the rotating shaft 311 and the shielding member 313 and is configured to provide an elastic force. When the shielding member 313 rotates along a first direction X, the shielding member 313 is in the state of opening the through hole 21. The elastic force is used for driving the shielding member 313 to rotate along a second direction Y to cause the shielding member 313 to be in the state of shielding the through hole 21. The second direction Y is opposite to the first direction X. It should be noted that, in an aspect, the elastic member 317 includes, but is not limited to, a compression spring, a tension spring, or the like.

In an aspect, the movable component 31 may be arranged on a side of the cover body 20 facing the body 10. In this way, in a process in which the aerosol generating substrate 200 extends into the heating cavity 11 through the through hole 21, an action force generated by the aerosol generating substrate 200 on the shielding member 313 is greater than an elastic force of the elastic member 317 on the shielding member 313. This enables the shielding member 313 to rotate toward a direction of the body 10 (that is, rotate along the first direction X) to be in the state of opening the through hole 21. In a process in which the aerosol generating substrate 200 is removed out of the heating cavity 11, an action force generated by the aerosol generating substrate 200 on the shielding member 313 gradually disappears. This enables the shielding member 313 to rotate toward a direction away from the body 10 (that is, rotate along the second direction Y) under the action of an elastic force of the elastic member 317, to be in the state of shielding the through hole 21. It should be noted that a cross-sectional size of the shielding member 313 is greater than or equal to a cross-sectional size of the through hole 21. This can ensure an effect of shielding the through hole 21 by the shielding member 313, and prevent external impurities such as water or dust from entering the heating cavity 11 through the through hole 21.

Referring to FIG. 2 to FIG. 4, in an aspect, when the cover body 20 is in the first state, if the shielding member 313 rotates along the first direction X relative to the cover body 20 to open the through hole 21, the shielding member 313 can drive the detected member 315 to rotate to cause the detected member 315 to enter the detection range of the detecting member 33. If the shielding member 313 rotates along the second direction Y relative to the cover body 20 to shield the through hole 21, the detected member 315 exceeds the detection range of the detecting member 33. In this way, when the cover body 20 is in the first state, the detecting member 33 can detect the detected member 315 to determine whether the aerosol generating substrate 200 is accommodated in the heating cavity 11.

Referring to FIG. 5 to FIG. 7, when the cover body 20 is in the second state, regardless of whether the shielding member 313 shields or opens the through hole 21, the detected member 315 exceeds the detection range of the detecting member 33. In this case, when the cover body 20 is in the second state, the detecting member 33 cannot detect the detected member 315 to determine whether the aerosol generating substrate 200 is accommodated in the heating cavity 11.

In an aspect, the detected member 315 may be arranged on the shielding member 313 in a non-detachable connection manner. This can improve binding strength between the detected member 315 and the shielding member 313, and prevent the detected member 315 from falling off the shielding member 313 during the rotation of the shielding member 313, thereby ensuring normal working of the detection assembly 30. The non-detachable connection manner includes, but is not limited to, bonding, welding, or the like. In some other implementations, the detected member 315 may be arranged on the shielding member 313 in a detachable connection manner. This facilitates removal of the detected member 315 for repair or replacement when damaged, thereby ensuring normal working of the detection assembly 30. The detachable connection manner includes, but is not limited to, a snapping connection, a threaded connection, or the like. It may be understood that the second connector 43 may alternatively be arranged on the body 10 in a non-detachable or detachable connection manner.

In an aspect, the detecting member 33 may be a Hall effect sensor switch, a photoelectric sensor, a crash sensor, or the like. This is not limited herein. The detected member 315 may be a device capable of cooperating with the detecting member 33 to enable the detecting member 33 to determine whether the aerosol generating substrate 200 is accommodated in the heating cavity 11.

In an aspect, the detecting member 33 may be a Hall switch, and the detected member 315 may be a magnetic element (for example, a permanent magnet). The Hall switch is configured to detect a magnetic field of the magnetic element to determine whether the through hole is in an open state or a closed state. In other words, the Hall switch can determine, based on the magnetic field of the magnet, whether the aerosol generating substrate 200 is accommodated in the heating cavity 11. When the aerosol generating substrate 200 is accommodated in the heating cavity 11, the detecting member 33 can output a heating signal to cause the aerosol generating substrate 200 to be heated to generate an aerosol. In an aspect, the detecting member 33 may be one of a transmit end or a receive end of the photoelectric sensor. In this case, the detected member 315 may be the other of the transmit end or the receive end. In this way, the detecting member 33 can determine, based on whether an optical signal sent by the transmit end is received, whether the aerosol generating substrate 200 is accommodated in the heating cavity 11.

Referring to FIG. 2 and FIG. 5, in an aspect, when the cover body 20 is in the second state, the cover body 20 is separated from the body 10. In an aspect, when the cover body 20 is manually intervened to completely separate the cover body 20 from the body 10, the cover body 20 is in the second state. In this case, the heating cavity 11 is in a completely open state, that is, the heating cavity 11 can be in communication with the outside through the opening 13, thereby making it easier for the user to perform a cleaning operation on the heating cavity 11.

Referring to FIG. 2, FIG. 6, and FIG. 7, when the cover body 20 is in the second state, the cover body 20 is at least partially connected to the body 10. In an aspect, when the cover body 20 is manually intervened to at least partially separate the cover body 20 from the body 10, the cover body 20 is in the second state. In this case, the heating cavity 11 can also be in a completely open state, that is, the heating cavity 11 can be in communication with the outside through the opening 13, thereby making it easier for the user to perform a cleaning operation on the heating cavity 11. In addition, compared with the case in which the cover body 20 is completely separated from the body 10, the case in which the cover body 20 is at least partially connected to the body 10 can further prevent the cover body 20 from being lost, thereby improving user experience.

Referring to FIG. 6, the cover body 20 is movable relative to the body 10 to cause the cover body 20 to open the opening 13 or align the opening 13 with the through hole 21. Specifically, when the cover body 20 is in the first state, the opening 13 can be aligned with the through hole 21. To be specific, a central axis of the opening 13 can coincide with a central axis of the through hole 21. In addition, when the movable component 31 rotates relative to the cover body 20, the movable component 31 can block or enable communication between the through hole 21 and the opening 13. When the cover body 20 moves (slides) relative to the body 10 to switch from the first state to the second state, the cover body 20 is at least partially connected to the body 10, and the cover body 20 can open the opening 13. The central axis of the opening 13 does not coincide with the central axis of the through hole 21. When the movable component 31 rotates relative to the cover body 20, the heating cavity 11 can always be in communication with the outside through the opening 13.

Referring to FIG. 7, the cover body 20 is rotatable relative to the body 10 to cause the cover body 20 to open the opening 13 or align the opening 13 with the through hole 21. Specifically, when the cover body 20 is in the first state, the opening 13 can be aligned with the through hole 21. To be specific, a central axis of the opening 13 can coincide with a central axis of the through hole 21. In addition, when the movable component 31 rotates relative to the cover body 20, the movable component 31 can block or enable communication between the through hole 21 and the opening 13. When the cover body 20 rotates (including rotation in a pivoting or flipping manner, or the like) relative to the body 10 to switch from the first state to the second state, the cover body 20 is at least partially connected to the body 10, and the cover body 20 can open the opening 13. The central axis of the opening 13 does not coincide with the central axis of the through hole 21. When the movable component 31 rotates relative to the cover body 20, the heating cavity 11 can always be in communication with the outside through the opening 13.

Referring to FIG. 2, in an aspect, the aerosol generating device 100 may further include a connection assembly 40 (an adhesive, a screw, a fastener, a magnet, or the like). The connection assembly 40 is configured to connect the body 10 and the cover body 20. It should be noted that, in an aspect, the connection assembly 40 includes, but is not limited to, a bolt, a fastener, a magnetic member, or the like.

In an aspect, the cover body 20 may be detachably connected to the body 10 by using the connection assembly 40, to enable the cover body 20 to switch between the first state and the second state, thereby enabling the opening 13 to be aligned with the through hole 21 or enabling the cover body 20 to open the opening 13. When the cover body 20 is connected to the body 10 by using the connection assembly 40, the cover body 20 is in the first state, and the opening 13 can be aligned with the through hole 21. In this case, the movable component 31 can rotate relative to the cover body 20 to block or enable communication between the through hole 21 and the opening 13. When the cover body 20 is detached from the body 10, the cover body 20 switches from the first state to the second state, and the cover body 20 can open the opening 13. In this case, when the movable component 31 rotates relative to the cover body 20, the heating cavity 11 can always be in communication with the outside through the opening 13.

Further, still referring to FIG. 2, in an aspect, the connection assembly 40 includes a first connector 41 and a second connector 43. The first connector 41 is arranged on the cover body 20. The second connector 43 is arranged on the body 10. The first connector 41 cooperates with the second connector 43 to connect the cover body 20 to the body 10.

In an aspect, the first connector 41 may be arranged on the cover body 20 in a non-detachable connection manner. This can improve binding strength between the first connector 41 and the cover body 20, and prevent the first connector 41 from falling off the cover body 20 when the first connector 41 is disconnected from the second connector 43, thereby improving stability and reliability of the connection between the cover body 20 and the body 10. The non-detachable connection manner includes, but is not limited to, bonding, welding, or the like. In some other implementations, the first connector 41 may be arranged on the cover body 20 in a detachable connection manner. This facilitates removal of the first connector 41 for replacement when the first connector 41 is damaged, thereby ensuring a normal connection between the cover body 20 and the body 10. The detachable connection manner includes, but is not limited to, a snapping connection, a threaded connection, or the like. It may be understood that the second connector 43 may alternatively be arranged on the body 10 in a non-detachable or detachable connection manner. The non-detachable connection manner includes, but is not limited to, bonding, welding, or the like. The detachable connection manner includes, but is not limited to, a snapping connection, a threaded connection, or the like.

Further, in an aspect, one of the first connector 41 and the second connector 43 is a magnetic member and the other is an adsorption member. The magnetic member cooperates with the adsorption member to connect the cover body 20 to the body 10. Specifically, when the first connector 41 and the second connector 43 are close to each other, a magnetic field of the magnetic member can act on the adsorption member to generate an attractive force on the adsorption member. The attraction force can connect the cover body 20 to the body 10.

In an aspect, the adsorption member may be made of iron or a soft magnetic material. For example, when the adsorption member is made of a soft magnetic material, and when the magnetic member comes into contact (including direct contact or indirect contact) with the adsorption member, the adsorption member can generate a magnetic field under the action of the magnetic field of the magnetic member and be attracted to the magnetic member. This enables the adsorption member to cooperate with the magnetic member, thereby connecting the cover body 20 to the body 10.

In an aspect, the magnetic member is arranged on the cover body 20, and the adsorption member is arranged on the body 10. This can increase a distance between the magnetic member and the detecting member 33, and prevent the magnetic field of the magnetic member from interfering with the detecting member 33, thereby improving accuracy of the detecting member 33 in detecting whether the aerosol generating substrate 200 is accommodated in the heating cavity 11.

In an example, the magnetic member is arranged on the body 10, and the adsorption member is arranged on the cover body 20. In this case, to prevent the magnetic field of the magnetic member from interfering with the detecting member 22, the aerosol generating device 100 may further include a blocking member (not shown). The blocking member covers the magnetic member. The blocking member is configured to block the magnetic field of the magnetic member towards the detecting member 33. In this way, interference from the magnetic field of the magnetic member with the detecting member 33 can be reduced or even avoided, thereby further improving accuracy of the detecting member 33 in detecting whether the aerosol generating substrate 200 is accommodated in the heating cavity 11. It should be noted that, in an aspect, the blocking member may be made of a material such as mild steel, silicon steel, or a silicon steel sheet.

It may be understood that, referring to FIG. 7, in an aspect, besides the first connector 41 and the second connector 43, the connection assembly 40 may further include a third connector (not shown). The cover body 20 is rotatably connected to the body 10 through the third connector. In this way, when the first connector 41 and the second connector 43 are disengaged, a partial structure of the cover body 20 can remain connected to the body 10 through the third connector, and the cover body 20 can rotate relative to the body 10 through the third connector to cause the cover body 20 to switch from the first state to the second state. In this case, the cover body 20 opens the opening 13, and the detected member 315 exceeds the detection range of the detecting member 33. It should be noted that, in an aspect, the third connector may be a hinge, a swivel, or the like. This is not limited herein.

The technical features of the foregoing embodiments can be described in any combination. For ease of description, not all possible combinations of the technical features in the foregoing embodiments are described. However, as long as there is no contradiction between the combinations of the technical features, all the combinations should be construed as falling within the scope described in this specification. Moreover, other implementations can be derived from the above embodiments, so that structural and logical replacements and changes can be made without departing from the scope of the present disclosure.

Only several implementations of this disclosure are described in the above embodiments. These implementations are specifically described in detail, but cannot be construed as limiting the scope of the patent. It should be noted that a person of ordinary skill in the art can further make several variations and improvements without departing from the idea of this disclosure. These variations and improvements all fall within the protection scope of this disclosure. Therefore, the protection scope of the patent of this disclosure shall be subject to the appended claims.

What is claimed is:

1. An aerosol generating device comprising:
a body including a heating cavity, and the heating cavity being configured to accommodate an aerosol generating substrate;
a cover body including a through hole, and the cover body being switchable between a first state and a second state relative to the body, wherein in the first state the through hole is in communication with the heating cavity;
a detection assembly including a movable component and a detecting member,
the movable component including a detected member, wherein the movable component is arranged on the cover body and is movable relative to the cover body to be in a state of blocking the through hole or a state of not blocking the through hole; and
wherein
in the first state, the cover body is connected to the body, and the detecting member detects a state of the movable component relative to the through hole; and
in the second state, the detected member exceeds a detection range of the detecting member.

2. The aerosol generating device of claim 1, wherein
when the cover body is in the second state, the cover body is separated from the body.

3. The aerosol generating device of claim 1, wherein
when the cover body is in the second state, the cover body is partially connected to the body.

4. The aerosol generating device of claim 1, wherein the aerosol generating substrate extends through an opening of the body and is accommodated in the heating cavity.

5. The aerosol generating device of claim 4, wherein when the cover body is in the first state, the opening of the body corresponds to the through hole of the cover body, and the movable component is blocking communication between the through hole and the opening; and
when the cover body is in the second state, the cover body does not block the opening.

6. The aerosol generating device of claim 3, wherein
the cover body is detachably connected to the body to cause the cover body to open the opening or align the opening with the through hole.

7. The aerosol generating device of claim 3, wherein
the cover body is movable relative to the body to cause the cover body to open the opening or align the opening with the through hole.

8. The aerosol generating device of claim 3, wherein
the cover body is rotatable relative to the body to cause the cover body to open the opening or align the opening with the through hole.

9. The aerosol generating device of claim 1, wherein the movable component is rotatable relative to the cover body to switch between the state of blocking the through hole and the state of not blocking the through hole.

10. The aerosol generating device of claim 9, wherein the movable component comprises:
a rotating shaft is rotatably mounted on the cover body;
a shielding member is connected to the rotating shaft and rotatable together with the rotating shaft;
the detected member is arranged on the shielding member and rotatable together with the shielding member, and the detected member is configured to cooperate with the detecting member; and
an elastic member is connected to the rotating shaft and the shielding member and is configured to provide an elastic force.

11. The aerosol generating device of claim 10, wherein
when the shielding member rotates along a first direction, the elastic force is used for driving the shielding member to rotate along a second direction, and the second direction is opposite to the first direction.

12. The aerosol generating device of claim 1, wherein the aerosol generating device further comprises:
a connection assembly is configured to connect the body and the cover body.

13. The aerosol generating device of claim 12, wherein the connection assembly further comprises:
a first connector is arranged on the cover body; and
a second connector is arranged in the body, and the first connector cooperates with the second connector to connect the cover body to the body.

14. The aerosol generating device of claim 13, wherein
one of the first connector and the second connector is a magnetic member, and another one is an adsorption member, and the magnetic member cooperates with the adsorption member to connect the cover body to the body.

15. The aerosol generating device of claim 1, wherein
the detecting member is a Hall effect sensor switch,
the detected member is a magnetic element, and
the Hall effect sensor switch is configured to detect a magnetic field of the magnetic element to determine whether the through hole is in an open state or a closed state.

16. The aerosol generating device of claim 1, wherein the movable component is movable relative to the cover body to switch between the first state and the second state.

17. The aerosol generating device of claim 13, wherein the first connector is arranged on the cover body in a non-detachable connection manner.

18. The aerosol generating device of claim 13, wherein the second connector is arranged on the cover body in a non-detachable connection manner.

19. The aerosol generating device of claim 13, wherein the connection assembly further comprises a third connector through which the cover body is rotatably connected to the body.

20. The aerosol generating device of claim 1, wherein the aerosol generating device further comprises a heating component, the heating component is electrically connected to the detecting member, wherein the heating component heats an aerosol generating substrate accommodated in the heating cavity.
